(19) United States
(12) Patent Application Publication
(10) Pub. No.: US 2009/0158907 A1
(43) Pub. Date: Jun. 25, 2009

(54) LASER MARKING DEVICE FOR A SAWING MACHINE

(75) Inventors: Hung-Jung CHIANG, Taichung Hsien (TW); Sean Chen, Tainan City (TW)

Correspondence Address: OHLANDT, GREELEY, RUGGIERO & PERLE, LLP, ONE LANDMARK SQUARE, 10TH FLOOR, STAMFORD, CT, 06901, US

(73) Assignee: REXON INDUSTRIAL CORP., LTD.,

(21) Appl. No.: 12/339,654

(22) Filed: Dec. 19, 2008

(30) Foreign Application Priority Data
Dec. 25, 2007 (TW) 096149898

(51) Int. Cl. B26D 7/00

(52) U.S. Cl. 83/520

(57) ABSTRACT

A laser marking device for a sawing machine includes a heat dissipating member and a laser module. The heat dissipating member is adapted to be connected to a saw head of the sawing machine adjacent to a cutting blade, and includes a tubular shell having an inner tubular surface which defines a receiving space for receiving the laser module, and a fin unit extending from the tubular shell so as to dissipate heat emanating from the tubular shell. The laser module includes a laser light emitting head which emits a beam of laser light so as to form a cutting line on the workpiece.

### CROSS-REFERENCE TO RELATED APPLICATION

This application claims priority of Taiwanese patent Application No. 096149898, filed on Dec. 25, 2007.

### BACKGROUND OF THE INVENTION

1. Field of the Invention

This invention relates to a laser marking device for a sawing machine, more particularly to a laser marking device having a heat sink to dissipate heat generated by light emitted from a laser module.

2. Description of the Related Art

Referring to FIG. 1, a sawing machine 10 disclosed in Taiwanese Utility Model No. M286734 includes a support unit 11, a motor 12 mounted on the support unit 11, a saw blade 13 pivotally disposed in the support unit 11 and rotated by the motor 12, and a laser marking device 14 coaxial with the saw blade 13. The laser marking device 14 includes a disc body 141 and a laser module 142 disposed in the disc body 141 and having an emitting end. The emitting end of the laser module 142 emits a red dot light beam. When the disc body 141 is rotated with the saw blade 13 during a cutting operation, a line of laser light is formed by the red light dots projected on a workpiece (not shown) to be cut so as to guide cutting of the workpiece by the saw blade 13. Generally, green laser light is preferred because it has a wavelength of about 550 nm-560 nm and is therefore brighter or clearer to the human eye.

Referring to FIG. 2, a miter saw 20 having a laser marking apparatus 21 as disclosed in U.S. Publication No. 2004/0170202 A1 includes a worktable 22, a cutting unit 23 pivotably mounted on a rear side of the worktable 22, a motor 24 disposed on the cutting unit 23, and a saw blade 25 rotated by the motor 24. The laser marking apparatus 21 is disposed on a lower portion of the cutting unit 23, is aligned with the cutting edge of the saw blade 25, and has a laser module 211 for emitting a green laser light toward the worktable 22. Although green light is more discernible than red light, the range of operating temperatures of a green light laser module is smaller than that of a red light laser module, so that the green light laser module is liable to be damaged in a high-temperature environment, i.e., near the high-speed rotating saw blade 25, and is not suitable for a long-term use.

Referring to FIG. 3, a laser module 30 disclosed in Taiwanese Utility Model No. 340689 includes a circuit board 31, a metal plate 32 disposed on the circuit board 31, and a laser diode 33 bonded to the metal plate 32 such that heat generated by the laser diode 33 can be conducted and dissipated via the metal plate 32. However, since the laser diode 33 is sealed in a package together with other component parts, such as lenses, mirrors, etc., to form the laser module 30, the heat conducted from the laser diode 33 to the metal plate 32 is difficult to be dissipated to the outside of the package. Thus, the efficiency of heat dissipation is unsatisfactory.

### SUMMARY OF THE INVENTION

An object of the present invention is to provide a laser marking device for a sawing machine which has a heat sink to achieve highly efficient heat dissipation.

According to this invention, the laser marking device for a sawing machine includes a heat dissipating member and a laser module. The heat dissipating member is adapted to be connected to a saw head of the sawing machine adjacent to a cutting blade, and includes a tubular shell and a fin unit. The tubular shell has an inner tubular surface which surrounds a lengthwise axis and which defines a receiving space with an access opening that is directed to confront forwards. The fin unit is configured to extend from the tubular shell in a direction parallel to a revolving axis of the cutting blade so as to dissipate heat emanating from the tubular shell. The laser module includes a casing which is inserted into the receiving space from the access opening and which is surrounded by the inner tubular surface, and a laser light emitting head which is disposed in the casing and which emits a beam of laser light through the access opening to form a cutting line on the workpiece.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary sectional view of a conventional sawing machine with a red light laser marking module;

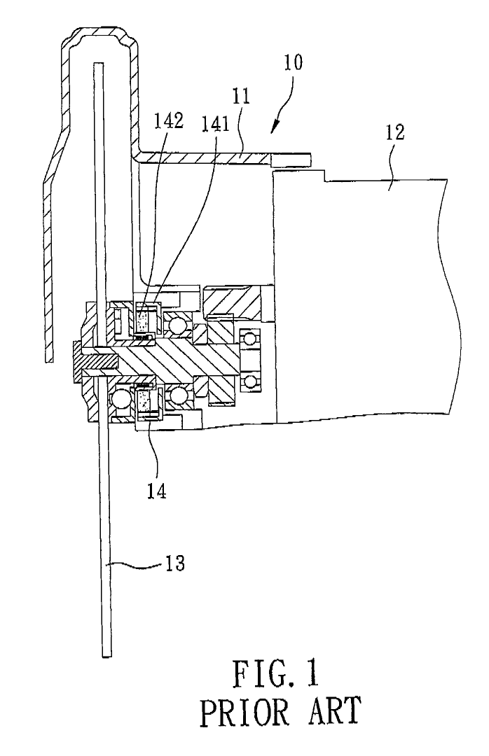

FIG. 2 is a schematic side view of a conventional sawing machine with a green light laser marking module;

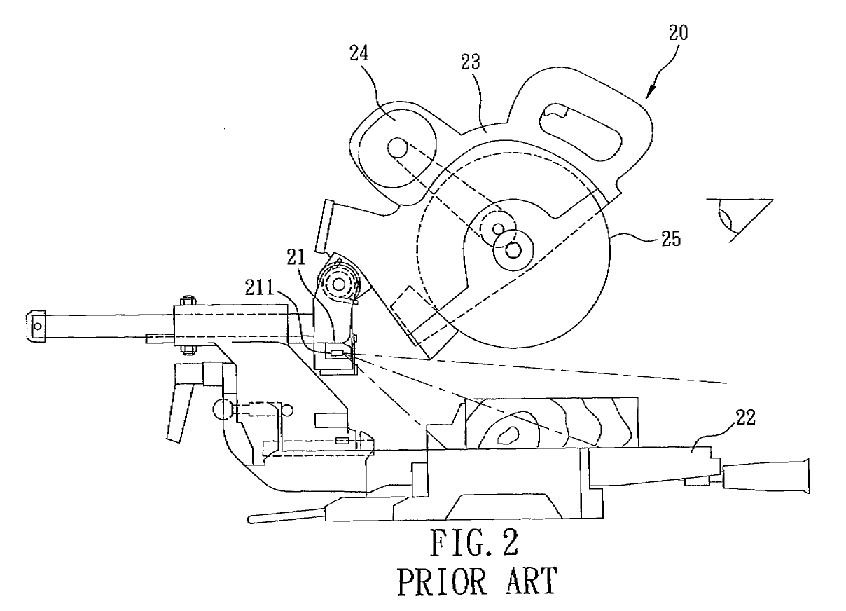

FIG. 3 is a perspective view of a conventional laser module;

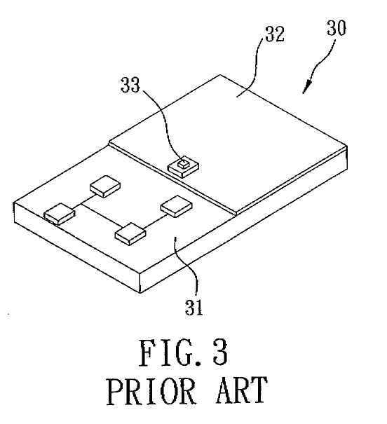

FIG. 4 is a perspective view of the first preferred embodiment of a laser marking device according to this invention when mounted on a sawing machine;

FIG. 5 is an exploded perspective view of the first preferred embodiment;

FIG. 6 is a bottom view of the first preferred embodiment;

FIG. 7 is a front view of the first preferred embodiment;

FIG. 8 is a front view of the second preferred embodiment of a laser marking device according to this invention;

FIG. 9 is a front view of the third preferred embodiment of a laser marking device according to this invention;

FIG. 10 is a front view of the fourth preferred embodiment of a laser marking device according to this invention;

FIG. 11 is a front view of the fifth preferred embodiment of a laser marking device according to this invention; and

FIG. 12 is a front view of the sixth preferred embodiment of a laser marking device according to this invention.

### DETAILED DESCRIPTION OF THE PREFERRED EMBODIMENTS

Before the present invention is described in greater detail, it should be noted that same reference numerals have been used to denote like elements throughout the specification.

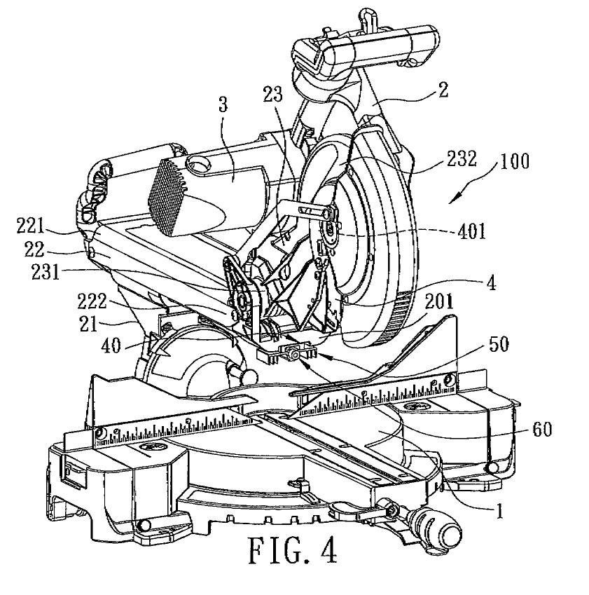

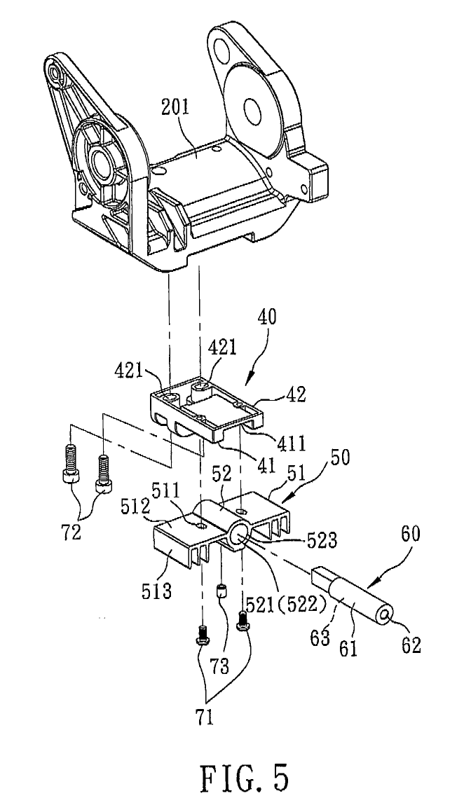

Referring to FIGS. 4 and 5, the first preferred embodiment of a laser marking device according to the present invention is adapted to be used in a sawing machine 100, such as a circular saw, to guide cutting of a workpiece (not shown) by a cutting blade 4, such as a circular saw blade. The sawing machine 100 includes a worktable 1 for placement of a workpiece to be cut thereon, a saw head 2, and a drive motor 3 mounted on the saw head 2 to drive rotation of the cutting blade 4. The saw head 2 includes a supporting post 21 which is disposed rearwardly of the worktable 1 and which extends upwardly to terminate at a support end, a cantilevered mount 22 which has a rear end 221 disposed on the support end, and a front end 222 opposite to the rear end 221 in a longitudinal direction, and a cutting unit including a carrier frame 23 and the cutting blade 4. The carrier frame 23 has an anchor portion 231 which is pivotally mounted on the front end 222 about a pivot axis through a sliding seat 201, and a blade-carrying portion 232 which is turnable about the pivot axis between normal and held positions relative to the worktable 1. The cutting blade 4, which is provided with an arbor 401, is revolvably mounted on the blade-carrying portion 232 about a revolving axis that is parallel to the pivot axis. When the blade-carrying portion 232 is in the held position, the cutting blade 4 is brought to cut the workpiece along a cutting line in the longitudinal direction.

The laser marking device according to the preferred embodiment of this invention is shown to comprise a mount seat 40, a heat dissipating member 50, and a laser module 60.

The mount seat 40 has an upper wall 42 which has two locking holes 421 so as to be secured on the sliding seat 201 by means of two screw fasteners 72, and a lower wall 41 which has an engaging groove 411 extending in the longitudinal direction. It is noted that the mount seat 40 may also be adapted to be secured on other portions of the saw head 2, such as the front end 222 of the cantilevered mount 22, the blade-carrying portion 232, and the arbor 401 of the cutting blade 4, to be registered with the cutting edge of the cutting blade 4.

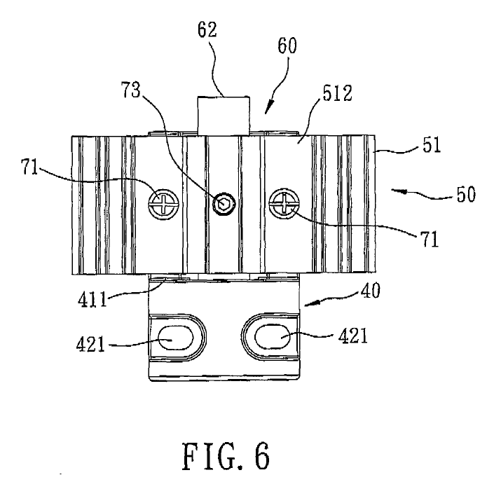

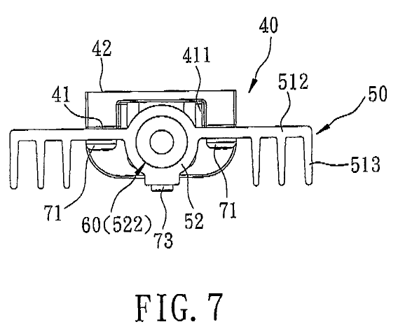

The heat dissipating member 50 is of a single-piece construction, and is made from an alloy of aluminum and magnesium with good heat conductivity. The heat dissipating member 50 includes a tubular shell 52 and a fin unit 51. The tubular shell 52 has an inner tubular surface 521 which surrounds a lengthwise axis in the longitudinal direction, and which defines a receiving space 522 with an access opening 523 that is directed to confront forwards. The fin unit 51 includes a connected plate 512 which extends from and which is disposed outboard of the tubular shell 52 in a transverse direction parallel to the revolving axis and which has two through holes 511. The tubular shell 52 is inserted into the engaging groove 411 to enable the connected plate 512 to be secured on the mount seat 40 by means of two screw fasteners 71, as shown in FIGS. 6 and 7. The fin unit 51 further includes a plurality of fins 513 which extend downwardly from the connected plate 512 and which are spaced apart from each other in the transverse direction so as to dissipate heat emanating from the tubular shell 52.

The laser module 60 includes a casing 61 which is inserted into the receiving space 522 from the access opening 523 and which is surrounded by the inner tubular surface 521, and a laser light emitting head 62 which is disposed in the casing 61 and which emits a beam of laser light through the access opening 523 so as to form the cutting line on the workpiece. In this embodiment, the casing 61 is made from a copper alloy, and is configured to be fitted to the inner tubular surface 521 to be secured in the receiving space 522 by means of a screw fastener 73. Thus, the heat generated by the laser module 60 can be dissipated through the casing 61, the inner tubular surface 522 and the fin unit 51. Preferably, the laser module 60 emits a beam of green laser light. In addition, the laser module 60 further includes a time control circuit 63 to automatically switch off the laser module 60 when it has operated for a predetermined period of time, e.g., ten minutes, thereby preventing overheating of the laser module 60 due to high temperature.

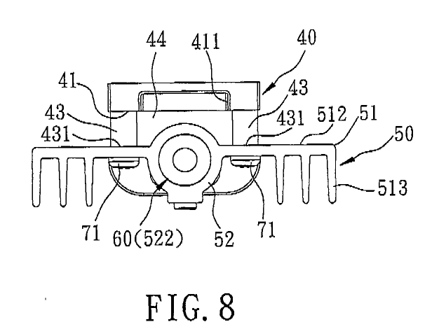

Referring to FIG. 8, the second preferred embodiment of a laser marking device according to this invention is similar to that of the first embodiment in construction, except that the second preferred embodiment further includes two connecting spacers 43 that extend downwardly from the lower wall 41 of the mount seat 40 to terminate at lower ends 431, respectively. The lower ends 431 are engaged securely with the connected plate 512 by means of the screw fasteners 71 so as to define a heat dissipating space 44 between the lower wall 41 and the tubular shell 52, thereby enhancing the heat dissipating effect.

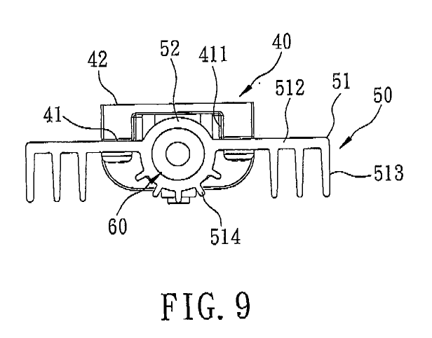

Referring to FIG. 9, the third preferred embodiment of a laser marking device according to this invention is similar to that of the first embodiment in construction, except that the fin unit 51 of the third preferred embodiment further includes a plurality of fins 514 which extend radially from the tubular shell 52 and which are angularly displaced from one another about the lengthwise axis. The heat dissipating effect can likewise be enhanced.

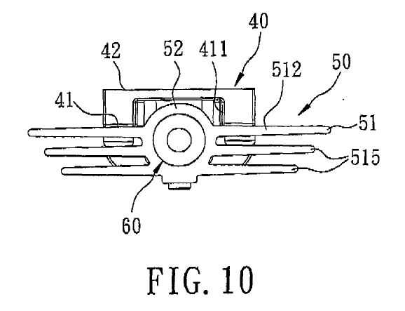

Referring to FIG. 10, the fourth preferred embodiment of a laser marking device according to this invention is similar to that of the first embodiment in construction. In the fourth embodiment, instead of the downwardly extending fins 513, the fin unit 51 includes a plurality of fins 515 which extend from the tubular shell 52 in the transverse direction.

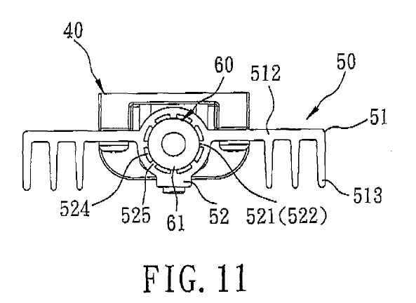

Referring to FIG. 11, the fifth preferred embodiment of a laser marking device according to this invention is similar to that of the first embodiment in construction, except that, in the fifth preferred embodiment, the inner tubular surface 521 of the tubular shell 52 has a plurality of recesses 524 which extend radially and outwardly and which are angularly displaced from one another about the lengthwise axis, and a plurality of ribs 525, each of which is formed between each adjacent pair of the recesses 524 to be in contact with the casing 61 of the laser module 60. The heat generated by the laser module 60 can be conducted through the ribs 525 and can flow out of the receiving space 522 through the recesses 524, thereby enhancing the heat dissipating effect.

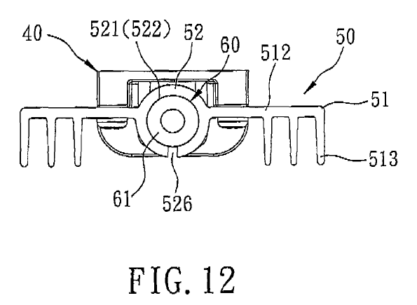

Referring to FIG. 12, the sixth preferred embodiment of a laser marking device according to this invention is similar to that of the first embodiment in construction, except that, in the sixth preferred embodiment, the inner tubular surface 521 has a clearance 526 which extends radially and outwardly through the tubular shell 52 so as to communicate the receiving space 522 with ambient air. By virtue of the provision of the clearance 526, the tubular shell 52 is deformable to facilitate insertion of the laser module 60 into the receiving space 522. Besides, the heat generated by the laser module 60 can be conducted through the inner tubular surface 521 and can flow out of the receiving space 522 through the clearance 526, thereby enhancing the heat dissipating effect.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

We claim:

1. A laser marking device for a sawing machine which includes:
a worktable for placement of a workpiece to be cut thereon;
a cantilevered mount disposed above the worktable and having a front end; and
a cutting unit including a carrier frame which has an anchor portion pivotally mounted on the front end about a pivot axis, and a blade-carrying portion which is turnable about the pivot axis between normal and held positions relative to the worktable, and a cutting blade provided with an arbor, and revolvably mounted on the blade-carrying portion about a revolving axis that is parallel to the pivot axis such that, when the blade-carrying portion is in the held position, the cutting blade is brought to cut the workpiece along a cutting line in the longitudinal direction,
said laser marking device comprising:
a heat dissipating member which is adapted to be connected to one of the front end of the cantilevered mount, the blade-carrying portion, and the arbor, and which includes
a tubular shell having an inner tubular surface which surrounds a lengthwise axis in a longitudinal direction transverse to the revolving axis, and which defines a receiving space with an access opening that is directed to confront forwards, and
a fin unit configured to extend outwardly from said tubular shell so as to dissipate heat emanating from said tubular shell; and
a laser module including a casing which is inserted into said receiving space from said access opening and which is surrounded by said inner tubular surface, and a laser light emitting head which is disposed in said casing and which emits a beam of laser light through said access opening so as to form the cutting line on the workpiece.

2. The laser marking device according to claim 1, wherein said fin unit is configured to extend from said tubular shell in a transverse direction parallel to the revolving axis.

3. The laser marking device according to claim 2, wherein said fin unit includes a connected plate which extends from and which is disposed outboard of said tubular shell in the transverse direction, and which is adapted to be connected to the one of the front end of the cantilevered mount, the blade-carrying portion, and the arbor.

4. The laser marking device according to claim 3, further comprising a mount seat which has an upper wall adapted to be secured on the one of the front end of the cantilevered mount, the blade-carrying portion, and the arbor, and a lower wall defining an engaging groove which extends in the longitudinal direction, said tubular shell being inserted into said engaging groove to enable said connected plate to be connected to the one of the front end of the cantilevered mount, the blade-carrying portion, and the arbor.

5. The laser marking device according to claim 4, further comprising a connecting spacer which extends downwardly from said lower wall of said mount seat to terminate at a lower end, said lower end being engaged with said connected plate so as to define a heat dissipating space between said lower wall and said tubular shell.

6. The laser marking device according to claim 3, wherein said fin unit further includes a plurality of fins which extend downwardly from said connected plate and which are spaced apart from each other in the transverse direction.

7. The laser marking device according to claim 3, wherein said fin unit further includes a plurality of fins which extend radially from said tubular shell and which are angularly displaced from one another about the lengthwise axis.

8. The laser marking device according to claim 3, wherein said fin unit further includes a plurality of fins which extend from said tubular shell in the transverse direction.

9. The laser marking device according to claim 2, wherein said inner tubular surface has a plurality of recesses which extend radially and outwardly and which are angularly displaced from one another about the lengthwise axis.

10. The laser marking device according to claim 2, wherein said inner tubular surface has a clearance which extends radially and outwardly through said tubular shell so as to communicate said receiving space with ambient air.

11. The laser marking device according to claim 1, wherein said heat dissipating member is of a single-piece construction and is made from an alloy of aluminum and magnesium.

12. The laser marking device according to claim 1, wherein said casing of said laser module is made from a copper alloy.

13. The laser marking device according to claim 1, wherein said laser module further includes a time control circuit for switching off said laser module at predetermined times.

14. The laser marking device according to claim 1, wherein said laser module emits a beam of green laser light.

15. A laser marking device for a sawing machine, comprising:
a heat dissipating member which is adapted to be connected to the sawing machine, and which includes
a tubular shell having an inner tubular surface which surrounds a lengthwise axis, and which defines a receiving space with an access opening that is directed to confront forwards, and
a fin unit configured to extend outwardly from said tubular shell so as to dissipate heat emanating from said tubular shell; and
a laser module including a casing which is inserted into said receiving space from said access opening and which is surrounded by said inner tubular surface, and a laser light emitting head which is disposed in said casing and which emits a beam of laser light through said access opening.
